(19) United States
(12) Patent Application Publication
(10) Pub. No.: US 2025/0177955 A1
(43) Pub. Date: Jun. 5, 2025

(54) REGENERABLE GAS ABSORPTION MATERIAL AND DEVICE

(71) Applicant: EXPOSOME PVT. LTD., Mumbai (IN)

(72) Inventor: Prerna Goradia, Mumbai (IN)

(21) Appl. No.: 19/050,049

(22) Filed: Feb. 10, 2025

Related U.S. Application Data
(63) Continuation of application No. PCT/IN2023/050764, filed on Aug. 10, 2023.

(30) Foreign Application Priority Data
Aug. 10, 2022 (IN) 202221045609

(51) Int. Cl. B01J 20/28; B01D 53/02; B01J 20/04

(52) U.S. Cl. CPC B01J 20/28047; B01D 53/02; B01J 20/041; B01D 2252/10; B01J 2220/46

(57) ABSTRACT

The present invention relates to water based regenerable filters for absorbing the harmful gases and method of preparation thereof. The regenerable filters absorb gas components in the air and have excellent reversible absorption performance of gases such as carbon dioxide, ammonia, methane, halogens, hydrogen sulphide, sulphur dioxide and so on. The filters based on nanocomposite hydrogels or hybrid hydrogels, are highly hydrated polymeric networks, either physically or covalently crosslinked with each other and/or with nanoparticles or nanostructures with very large surface areas.

### RELATED APPLICATIONS

This application claims priority under 35 U.S.C. § 120 to, and is a continuation of, co-pending International Application PCT/IN2023/050764, filed Aug. 10, 2023 and designating the US, which claims priority to IN Application 202221045609, filed Aug. 10, 2022, such IN Application also being claimed priority to under 35 U.S.C. § 119. These IN and International applications are incorporated by reference herein in their entireties.

### FIELD

The present invention relates to a gas absorbing material. More particularly, the invention relates to regenerable water-based filters for absorbing the harmful gases and method of preparation thereof.

### BACKGROUND

Human activity has increased the concentration of carbon dioxide and other greenhouse gases in the environment which is a major concern these days. In commercial buildings, air quality is often maintained by replacing indoor air to reduce carbon dioxide concentrations to safe levels. Absorption, or gas absorption, is a unit operation used in the chemical industry to separate gases by washing or scrubbing a gas mixture with a suitable liquid and the fundamental physical principles underlying the process of gas absorption are the solubility of the absorbed gas and the rate of mass transfer.

Gas scrubber can be applied as emission control technique at various gaseous emissions. Gas scrubbers are cleanings installations in which the gas flow is brought in intensive contact with a fluid with an aim to remove the gaseous components from the gas to the fluid.

References have been made to the following literature:

JP1190219 relates to an adsorption-desorption material having a high carbon dioxide adsorption-desorption capability, a low-pressure loss, a high thermal diffusion efficiency, and high resistance to repeated stresses, e.g., expansion and shrinkage, as well as an adsorption-desorption apparatus including the adsorption-desorption material, is provided. The adsorbent is composed of a three-dimensional network skeleton structure or a structure having three-dimensional network voids, the structure constructed by a compound having a carbon dioxide adsorption-desorption capability.

U.S. Pat. No. 8,808,546B2 relates to a system and process for removing hydrocarbons from a gas process feed stream is presented. The treatment process may be, but is not limited to, glycol dehydration, amine sweetening, and MEG reclamation. As an example, a hydrocarbon removal bed containing a solid adsorbent material adsorbs the hydrocarbons in a rich MEG feed stream as it passes through the hydrocarbon removal bed. After the hydrocarbons have been removed, the feed stream flows through a flash separator and a distillation column to reclaim MEG.

WO2016024633A1 relates to a gel particle film of polymer compound particles having an amino group has a high acidic-gas absorption and dissipation per unit volume, a high acidic-gas absorption speed and dissipation speed per unit mass, and high stability. A gas absorption body in which this gel particle film is supported on a carrier is useful as an energy-efficient acidic-gas separation material.

JP2010167324A relates to a gas absorbing filter and a gas absorbing apparatus having a long service life by increasing the absorbing performance of 1 path and making it possible to increase the filling amount of an adsorbent.

CN1511081A relates to a gas absorbing material which comprises a high temperature charcoal having been carbonized at a temperature of about 800 DEG C. or higher, a low temperature charcoal having been carbonized at a temperature of about 500 DEG C. or lower, and alginic acid or a salt thereof or calcium oxide. The combined use of the high temperature charcoal, the low temperature charcoal, and an alginic acid component or calcium oxide has allowed the marked improvement of performance capabilities of charcoal for absorption of a gas. The gas absorbing material can be used as a gas absorbing material having excellent gas absorptivity, especially, for use as an interior building material for absorbing a toxic gas present in a room.

U.S. Pat. No. 8,211,202B2 relates to a gas-absorbing substance that contains at least Li and a solid material having a hardness of 5 or more, and absorbs at least nitrogen or oxygen at 25° C. under normal pressure, and a gas-absorbing alloy that contains at least two kinds of metals that are not allowed to mutually form an intermetallic compound, with a mixing enthalpy of the two kinds of metals being greater than o and at least one portion of the two kinds of metals being atomically mixed, and also concerns a gas-absorbing material that contains the gas-absorbing substance and the gas-absorbing alloy.

Research publication by Hikmet Sayilkan and Ertuğrul Arpaç discusses about “The production and application of a regenerable filter system for adsorption of some atmospheric contaminants”. A new filter, used to prevent atmospherical pollution, has been developed. Spherical amorphous shaped silicates (such as KC-Siliperl AF 125 and Aluminium silicate 596 FA) were coated with different materials which were prepared from the hydrolysis-condensation products of organically modified silanes and metal alkoxides. The adsorption capacities of such silicates for different solvents; ethyl acetate, toluene, n-hexane and cyclohexanone were investigated.

It is evident that though, these wet scrubbers are beneficial as they prevent a wide range of pollutants from entering the air through the exhaust gas, yet there are a few drawbacks. These machines require frequent maintenance, and can suffer from corrosion quite severely. Moreover, these scrubbers take a lot of area, require a lot of water and a large volume of effluents is also released. Thus, there is requirement of an alternative to these scrubbers. The present invention relates to water based regenerable filters for absorbing the harmful gases and method of preparation thereof. The regenerable filters absorb gas components in the air and have excellent reversible absorption performance of gases such as carbon dioxide, ammonia, methane, halogens, hydrogen sulphide, Sulphur dioxide and so on. The filters based on nanocomposite hydrogels or hybrid hydrogels, are highly hydrated polymeric networks, either physically or covalently crosslinked with each other and/or with nanoparticles or nanostructures and very large surface areas. A wide range of nanoparticles, such as carbon-based, polymeric, ceramic, and metallic nanomaterials can be incorporated within the hydrogel structure to obtain nanocomposites with tailored functionality. Nanocomposite hydrogels can be engineered to possess superior physical, chemical, electrical, thermal, and biological properties.

The information disclosed in this background of the disclosure section is only for enhancement of understanding of the general background of the invention and should not be taken as an acknowledgement or any form of suggestion that this information forms the prior art already known to a person skilled in the art.

### SUMMARY

The principal object of the present invention is to provide water based regenerable filters for absorbing the harmful gases and method of preparation thereof.

Another object of the invention is to provide regenerable hydrogel filters with excellent reversible absorption efficiency of gases such as carbon dioxide, ammonia, methane, halogens, hydrogen sulphide, Sulphur dioxide and so on.

The present invention attempts to overcome the problems faced in the prior art, and discloses water based regenerable filters for absorbing gas components in the air. The regenerable gel-based filters have excellent reversible absorption performance of gases such as carbon dioxide, ammonia, methane, halogens, hydrogen sulphide, Sulphur dioxide and so on.

In an embodiment of the present invention, the filters based on nanocomposite hydrogels or hybrid hydrogels, are highly hydrated polymeric networks and crosslinked with each other and/or with nanoparticles or nanostructures.

In an embodiment the present invention relates to a regenerable hydrogel filter media sorbent comprising of at least 10-50% wt/vol of a substrate; at least 0.1-1% wt/vol of a polymer material to hold water, wherein a crosslinking agent is added to trigger crosslinking of the polymer material; at least 0.1-5% wt/vol of an active material to help in the adsorption of gases; and at least 50-95% Wt/vol of water.

In yet another embodiment of the present invention, the substrate for the hydrogel filter media sorbent is at least one of carbon nanomaterials (carbon nanotubes or CNTs, graphene, nanodiamonds), polymeric nanoparticles (dendrimers and hyper-branched polymers), inorganic/ceramic nanoparticles (hydroxyapatite, silicates, alumina and calcium phosphate) and metal/metal oxide nanoparticles (gold, silver and iron oxides); inorganic nanoparticles comprising nano-hydroxyapatite (nHA), synthetic silicate nanoparticles (nanoclays), bioactive glasses, silica, calcium phosphate, glass ceramic and wollastonite such as CaSiO3 and combinations thereof.

In still another embodiment of the present invention, the polymer material to hold the water in the filter is at least one of synthetic polymers such as polyacrylamide, polyethylene glycols, polyethyl hydroxyethyl methacrylates, poly vinyl pyrrolidones, poly N-isopropyl acrylamide and poly acryl amide and also natural ones such as gelatin, alginate, chitosan, collagen, silk, cellulose, fibrin, hyaluronic acid and agarose and combinations thereof.

In an embodiment of the present invention, the crosslinking agent is at least one of a base such as NaOH ammonium hydroxides, amines; and/or radiations such as ultrasound, UV or γ-irradiation and combinations thereof and the active material to hold corrosive gases is at least one of KOH, calcium and magnesium oxides and combinations thereof.

In an exemplary embodiment of the present invention, the invention relates to a method for preparation of regenerable hydrogel filter media sorbent comprising the steps of (a) Preparing the hydrogel component by dissolving at least 0.1-1% wt/vol of a polymer in water; (b) adding at least a crosslinking agent to trigger and/or initiate the cross-linking and thickening of the hydrogel in the form of a layer; (c) adding at least 0.1-5% wt/vol of one active material to at least 10-50% wt/vol of a substrate by a mixing process to prepare an active substrate; (d) sandwiching and/or mixing the thickened hydrogel from step b with the active substrate, wherein the active material is mixed into the substrate with or without binders so that the gel composition is not disturbed when in contact. The hydrogel and the active substrate is mixed in different ratios such as 1:1 or 10:1 and also sandwiched into a panel type filters with the hydrogel sandwiched in the form of layers with the active substrate.

In an embodiment of the present invention, the hydrogel is produced as a chemical thermosetting gel by transforming the polymer water mixture to a cross-linked gel by introducing a crosslinker agent. In another embodiment of the present invention, the cross-linking of an existing polymer is performed with different routes such as heating, ultrasound, UV or γ-irradiation and combinations thereof to enable patterning of the filters using a mask.

In yet another embodiment of the present invention, for the regenerable nature of the filter, fresh water is added to the hydrogel filter media sorbent after treatment with corrosive gases to replenish the filter making it truly regenerable. In an embodiment corrosive gas laden water is condensed on a plate/radiator assembly that is in the path of the gas laden air and fresh water is added to the gel network to replenish the filter.

In still another embodiment of the present invention, the invention discloses a gas absorber system using the gas absorbing material, a gas separating material, a filter, and a gas separating device.

In another embodiment of the present invention, the end gels are often slightly alkaline if the acidic gases are to be dissolved, which increases the neutralization capacity of the filter. Similarly, the acidity and the alkalinity of the filter can be adjusted based on the target gases and the special chemical compositions for selective trapping of gases is also disclosed by the present invention.

In another preferred embodiment of the present invention, the invention discloses a regenerable filter device comprising a fan or a vacuum system where a negative pressure is created and the polluted gas is sucked into the filter and gets dissolved and adsorbed very efficiently into the media. Once the filter is fully saturated the heating coil can be switched on using a manual or automatic process and the water evaporates carrying the gas molecules with it. Either this can be sent into exhaust or collected using the condenser coils and appropriately discharged. Compared to wet scrubbers very small quantities of water are used up. The condensers can also be kept on if additional humidity in the outlet pump is not desired.

In still another embodiment of the present invention, the invention can be used in future for commercial sectors such as airports, hospitals, data centres, schools, residential and Industrial sectors such as oil and gas industries, cement, chemical manufacturing.

In yet another embodiment of the present invention, the invention provides an inexpensive, easily-manufacturable gas absorber that allows a significant reduction in human cost. The regeneration is based on the special responsiveness to radiation, temperature and electric or magnetic field due to the special composition. The environmental changes may induce swelling, water expulsion and absorption and the release of contents captured inside the network. This property makes the materials, of this invention, excellent for regeneration.

The foregoing summary is illustrative only and is not intended to be in any way limiting. In addition to the illustrative aspects, embodiments, and features described above, further aspects, embodiments, and features will become apparent by reference to the drawings and the following detailed description.

### DETAILED DESCRIPTION

While the embodiments of the disclosure are subject to various modifications and alternative forms, specific embodiments thereof have been shown by way of example in the figures and will be described below. It should be understood, however, that it is not intended to limit the disclosure to the particular forms disclosed, but on the contrary, the disclosure is intended to cover all modifications, equivalents, and alternatives falling within the scope of the disclosure. Further, the phraseology and terminology employed in the description is for the purpose of description only and not for the purpose of limitation.

The terms “comprises”, “comprising”, or any other variations thereof used in the disclosure, are intended to cover a non-exclusive inclusion, such that a device, apparatus, system, assembly, method that comprises a list of components or a series of steps that does not include only those components or steps but may include other components or steps not expressly listed or inherent to such apparatus, or assembly, or device. In other words, one or more elements or steps in a system or device or process proceeded by “comprises . . . a” or “comprising . . . of” does not, without more constraints, preclude the existence of other elements or additional elements or additional steps in the system or device or process as the case may be.

The primary object of the present invention is to provide water based regenerable filters for absorbing the harmful gases and method of preparation thereof.

In accordance with the embodiments of the present invention, the invention relates to water based regenerable filter media for absorbing gas components in the air. The gel-based filter media have excellent reversible absorption performance of gases such as carbon dioxide, ammonia, methane, halogens, hydrogen sulphide, sulphur dioxide and other gases from the air. The invention discloses a hydrogel based regenerable filter material/media comprising synthetic and natural polymers, calcium chloride, gel beads, absorbents with high surface areas such as zeolites, molecular sieves, calcium and magnesium oxides and nanomaterials for providing the scaffolding and structural support. The filters are based on nanocomposite hydrogels or also known as hybrid hydrogels. These are highly hydrated polymeric networks where hydration is generally 90% or above by volume, either physically or covalently crosslinked with each other and/or with nanoparticles or nanostructures. A wide range of nanoparticles, such as carbon-based, polymeric, ceramic, and metallic nanomaterials can be incorporated within the hydrogel structure to obtain nanocomposites with tailored functionality. Nanocomposite hydrogels can be engineered to possess superior physical, chemical, electrical, thermal, and biological properties.

In accordance with the embodiment the present invention relates to a regenerable hydrogel filter media sorbent comprising of at least 10-50% wt/vol of a substrate; at least 0.1-1% wt/vol of a polymer material to hold water, wherein a crosslinking agent is added to trigger crosslinking of the polymer material; at least 0.1-5% wt/vol of an active material to help in the adsorption of gases; and at least 50-95% wt/vol of water.

In an embodiment of the present invention, the substrate for the hydrogel filter media sorbent is at least one of carbon nanomaterials (carbon nanotubes or CNTs, graphene, nanodiamonds), polymeric nanoparticles (dendrimers and hyper-branched polymers), inorganic/ceramic nanoparticles (hydroxyapatite, silicates, alumina and calcium phosphate) and metal/metal oxide nanoparticles (gold, silver and iron oxides); inorganic nanoparticles comprising nano-hydroxyapatite (nHA), synthetic silicate nanoparticles (nanoclays), bioactive glasses, silica, calcium phosphate, glass ceramic and wollastonite such as CaSiO3 and combinations thereof.

In another embodiment of the present invention, the polymer material to hold the water in the filter is at least one of synthetic polymers such as polyacrylamide, polyethylene glycols, polyethyl hydroxyethyl methacrylates, poly vinyl pyrrolidones, poly N-isopropyl acrylamide and poly acryl amide and also natural ones such as gelatin, alginate, chitosan, collagen, silk, cellulose, fibrin, hyaluronic acid and agarose and combinations thereof.

In yet another embodiment of the present invention, the crosslinking agent is at least one of a base such as NaOH, ammonium hydroxide, amines; and/or radiations such as ultrasound, UV or γ-irradiation and combinations thereof and the active material to hold corrosive gases is at least one of KOH, calcium and magnesium oxides and combinations thereof.

In an exemplary embodiment of the present invention, the invention relates to a method for preparation of regenerable hydrogel filter media sorbent comprising the steps of (a) Preparing the hydrogel component by dissolving at least 0.1-1% wt/vol of a polymer in water; (b) adding at least a crosslinking agent to trigger and/or initiate the cross-linking and thickening of the hydrogel in the form of a layer; (c) adding at least 0.1-5% wt/vol of one active material to at least 10-50% wt/vol of a substrate by a mixing process to prepare an active substrate; (d) sandwiching and/or mixing the thickened hydrogel from step b with the active substrate, wherein the active material is mixed into the substrate with or without binders so that the gel composition is not disturbed when in contact. The hydrogel and the active substrate is mixed in different ratios such as 1:1 or 10:1 and also sandwiched into a panel type filters with the hydrogel sandwiched in the form of layers with the active substrate.

In an embodiment of the present invention, the hydrogel is produced as a chemical thermosetting gel by transforming the polymer water mixture to a cross-linked gel by introducing a crosslinker agent. In another embodiment of the present invention, the cross-linking of an existing polymer is performed with different routes such as heating, ultrasound, UV or γ-irradiation and combinations thereof to enable patterning of the filters using a mask.

In another embodiment of the present invention, for the regenerable nature of the filter, fresh water is added to the hydrogel filter media sorbent after treatment with corrosive gases to replenish the filter making it truly regenerable. In an embodiment corrosive gas laden water is condensed on a plate/radiator assembly that is in the path of the gas laden air and fresh water is added to the gel network to replenish the filter.

In yet another embodiment of the present invention, the selectivity is imparted by the selective adsorption of corrosive gases from air and gas streams using polymer networks of gel-based filters.

In accordance with the embodiments of the present invention, the regenerable filter media comprises of: acrylamide or polyacrylic acid polymers 1% or less (wt/V), carbon back-bone materials such as activated carbons about 50% (wt/V), and the final volume is made up with water. The gases dissolve in water very efficiently due to very large surface areas and the dissolution is dependent on the ability of the gases to dissolve. For instance, at 293 K, the following gases have a good solubility; weight in grams of gas dissolved in 100 g of water when the total pressure above the solution is 1 atm (Table 1).

TABLE 1

| Gas | Solubility* |
|---|---|
| Acetylene | 0.117 |
| Ammonia | 52.9 |
| Bromine | 14.9 |
| Carbon dioxide | 0.169 |
| Chlorine | 0.729 |
| Hydrogen sulfide | 0.385 |
| Sulfur dioxide | 11.28 |

On the other hand, the following gases do not have good solubility and the “soluble” gases can be removed selectively using the invented filter (Table 2). For instance, carbon dioxide gas can be selectively removed from air (mainly nitrogen and oxygen).

TABLE 2

| Gas | Solubility* |
|---|---|
| Ethane | 0.0062 |
| Ethylene | 0.0149 |
| Hydrogen | 0.00016 |
| Methane | 0.0023 |
| Nitrogen | 0.0019 |
| Oxygen | 0.0043 |

In another embodiment of the present invention, the invention discloses a gas absorber system using the gas absorbing material, a gas separating material, a filter, and a gas separating device. The system comprises a water-based gas absorbing material comprising polyacrylamide gel or gel beads, and prepared using processes of the said invention where the water content of the media is greater than 99% and the surface area of contact of the media is enhanced multifold. The condensation agents such as the alkali are added bit by bit to attain gelation with maximum surface area. The invention discloses two types of hydrogels based on the production method: chemical (thermosetting) gels, and physical (thermoplastic) gels. Chemical gels are covalently cross linked through different methods, such as polymerization in the presence of a cross-linker or cross-linking of an existing polymer with different routes such as heating, ultrasound, UV or γ-irradiation, etc. The invention covers both types of hydrogels, but predominantly chemical gels. The gel composition comprises synthetic polymers such as polyethylene glycols, polyethyl hydroxyethyl methacrylates, poly vinyl pyrrolidones, poly N-isopropyl acrylamide and poly acryl amide and also natural ones such as gelatin, alginate, chitosan, collagen, silk, cellulose, fibrin, hyaluronic acid and agarose.

In yet another embodiment of the present invention, the invention provides an inexpensive, easily-manufacturable gas absorber that allows a significant reduction in human cost. Further, the end gel filters are often slightly alkaline if the acidic gases are to be dissolved, which increases the neutralization capacity of the filter. Similarly, the acidity and the alkalinity of the filter can be adjusted based on the target gases.

In another preferred embodiment of the present invention, the invention discloses a regenerable filter device comprising a fan or a vacuum system where a negative pressure is created and the polluted gas is sucked into the filter and gets dissolved and adsorbed very efficiently into the media. Once the filter is fully saturated the heating coil can be switched on using a manual or automatic process and the water evaporates carrying the gas molecules with it. Either this can be sent into exhaust or collected using the condenser coils and appropriately discharged. Compared to wet scrubbers very small quantities of water are used up. The condensers can also be kept on if additional humidity in the outlet pump is not desired.

In still another embodiment of the present invention, the invention can be used in future for commercial sectors such as airports, hospitals, data centres, schools, residential and Industrial sectors such as oil and gas industries, cement, chemical manufacturing.

### EXAMPLES

Example 1: To determine the efficiency of the air filter for reduction of CO2 present in Indoor Air: 1% by weight of carbomer was mixed with water to become viscous gel by adjusting the pH to around 5 using a few drops of base such as sodium or ammonium hydroxide. Separately, 10 weight % of large grains of 4 by 8 activated carbon were mixed with 2% wt/vol of KOH. This mixture was then dried and mixed with the prepared gel to make a solid media. The end content of water in the filter is around 87%. This filter media was packed in a panel type filter and was used for determining the efficiency of the air filter for reduction of CO2 present in Indoor Air.

Air Filter was installed at a height of 1.0 meter from ground level and away from wall at distance of 1.0 meter and initial readings of CO2 was recorded by using Analyzer and the Purifier was started. Exposure time was 1 Hour & 2:30 Hours, after which the reading was recorded after 1 Hour & 2:30 Hour for CO2 by using Analyzer. It was observed that with 1 kg of this invention's media the CO2 level drops by 3500 ppm in a 9.81 m3 room. This was equivalent to an absorption of 61 g of CO2. There is a 40% reduction after installation of Air Filter for 1 Hour and 65% reduction after installation of Air Filter for 2:30 Hours (Table 3).

TABLE 3

| | | | | | Reduction |
|---|---|---|---|---|---|
| | | | Initial | Final | after 1 hr |
| Sr No | Parameter | Unit | Reading | Reading | (%) |
| 1 | CO2 | ppm | 1040 | 640 | 40% |
| 1 | CO2 | ppm | 1040 | 364 | 65 |

So, this invention's media has an absorption rate of

$$\frac{\frac{140 g of {CO}_{2}}{kg of media}}{hr}$$

which is much better than that of pure water

$$- \frac{\frac{28 g of {CO}_{2}}{kg of water}}{hr} .$$

The efficiency compared to water is 500%.

Example 2: In another experiment, the filter was freshly regenerated and it was observed that there was an excellent drop in CO2 of 75% in 30 min and some drop in the level of particles (Table 4).

TABLE 4

| time | 12:53 | 12:57 | 12:58 | 12:59 | 1:05 | 1:10 | 1:20 | 1:30 |
|---|---|---|---|---|---|---|---|---|
| CO₂ | >6000 | 4926 | 1887 | 1768 | 1475 | 1375 | 1260 | 1187 |
| PM 10 | | 20 | 20 | 21 | 21 | 18 | 18 | 17 |
| PM2.5 | | 16 | 16 | 16 | 16 | 16 | 14 | 14 |

Here, again, the filter was regenerated with flowing water for 30 minutes and it was observed that the Net CO2 levels were >5000 initially and dropped of 57% in 30 min (Table 5).

TABLE 5

| time | 2:00 | 2:05 | 2:10 | 2:15 | 2:20 | 2:25 | 2:30 |
|---|---|---|---|---|---|---|---|
| CO2 | 4275 | 3200 | 2555 | 2250 | 2001 | 1900 | 1816 |
| PM10 | 20 | 20 | 20 | 19 | 20 | 20 | 20 |
| PM2.5 | 16 | 16 | 16 | 16 | 16 | 16 | 16 |

Next, the filter was run without regenerating media and a drop of 22% in 30 min was seen (Table 6).

TABLE 6

| time | 12:15 | 12:20 | 12:225 | 12:30 | 12:35 | 12:40 | 12:45 |
|---|---|---|---|---|---|---|---|
| CO2 | 4008 | 4000 | 3642 | 3150 | 2595 | 2159 | 1903 |

Another version of the media was tested as shown below. A drop of 85% in 30 min was observed in this (Table 7).

TABLE 7

| time | 12:00 | 12:05 | 12:10 | 12:15 | 12:20 | 12:25 | 12:30 |
|---|---|---|---|---|---|---|---|
| Co2 | 4000 | 2300 | 854 | 698 | 614 | 568 | 590 |
| Pm10 | 35 | 33 | 33 | 33 | 33 | 28 | 28 |
| Pm2.5 | 27 | 27 | 27 | 26 | 25 | 23 | 23 |

On regeneration of above, a drop in CO2 of 75% in 30 min was recorded (Table 8).

TABLE 8

| time | 13:07 | 13:12 | 13:17 | 13:22 | 13:27 | 13:32 | 13:37 |
|---|---|---|---|---|---|---|---|
| CO2 | 3500 | 2326 | 1563 | 1320 | 1045 | 997 | 852 |
| PM10 | 32 | 31 | 31 | 30 | 29 | 30 | 29 |
| PM2.5 | 25 | 25 | 24 | 23 | 23 | 23 | 22 |

In accordance with advantages of the present invention as compared with the existing scrubbers, the present invention is to provide a big change in the field of gas absorbers from the air. The filter media of the invention consists of gels, gel balls, activated carbons and in some gases, mixtures of zeolites and certain calcium salts that can react with the corrosive gases. Besides, carbon can be added to give mechanical stability to the material.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

Although embodiments for the present invention have been described in language specific to structural features, it is to be understood that the present invention is not necessarily limited to the specific features described. Rather, the specific features and methods are disclosed as embodiments for the present invention. Numerous modifications and adaptations of the system/component of the present invention will be apparent to those skilled in the art, and thus it is intended by the appended claims to cover all such modifications and adaptations which fall within the scope of the present invention.

1. A regenerable hydrogel filter media sorbent comprising:
a substrate about 10 to 50% wt/vol of the sorbent;
a polymer material about 0.1 to 1% wt/vol of the sorbent, wherein the polymer material is configured to hold water, and wherein the polymer material is crosslinked;
an adsorption material about 0.1 to 5% wt/vol of the sorbent, wherein the adsorption material is configured to adsorb gases; and
water about 50 to 95% wt/vol of the sorbent.

2. The sorbent of claim 1, wherein the substrate includes at least one of carbon nanotubes, graphene, nanodiamonds, and nanoparticles, wherein the nanoparticles are at least one of polymeric, ceramic, metallic, metal oxide, nano-hydroxyapatite, synthetic silicate nanoclays, bioactive glasses, silica, calcium phosphate, glass ceramic, and wollastonite.

3. The sorbent of claim 1, wherein the polymer material includes at least one of a polyacrylamide, polyethylene glycol, polyethyl hydroxyethyl methacrylate, poly vinyl pyrrolidone, poly N-isopropyl acrylamide, poly acryl amide, gelatin, alginate, chitosan, collagen, silk, cellulose, fibrin, hyaluronic acid, and agarose.

4. The sorbent of claim 1, wherein the polymer material includes a crosslinking agent of at least one of NaOH, ammonium hydroxide, and an amine.

5. The sorbent of claim 1, wherein the polymer material has been subject to at least one of heating, ultrasound, UV irradiation, and γ-irradiation to create the crosslinking.

6. The sorbent of claim 1, wherein the adsorption material includes at least one of KOH, calcium oxide, and magnesium oxide.

7. The sorbent of claim 1, wherein the substrate includes nanoparticles, wherein the polymer material includes a crosslinking agent, and wherein the adsorption material is at least one of KOH, calcium oxide, and magnesium oxide.

8. A method for preparation of regenerable hydrogel filter media sorbent, the method comprising:
preparing a hydrogel component by dissolving about 0.1 to 1% wt/vol of a polymer in water;
adding a crosslinking agent to the component to thicken the hydrogel into a layer;
mixing an adsorbent material with a substrate to create an active substrate, wherein the substrate is 2 to 50 times the weight of the substrate in the active substrate;
sandwiching and/or mixing the layer of the thickened hydrogel with the active substrate, wherein the hydrogel is about 1 to 10 times the weight of the active substrate.

9. The method of claim 8, wherein the active material is mixed into the substrate so that the hydrogel is not disturbed when in contact with the active substrate.

10. The method of claim 8, wherein the sandwiching sandwiches the hydrogel into a panel type filter with the hydrogel sandwiched in layers with the active substrate.

11. The method of claim 8, further comprising:
transforming the polymer and water mixture to a cross-linked gel by introducing a crosslinker agent such that the hydrogel is a chemical thermosetting gel.

12. The method of claim 8, further comprising:
cross-linking they polymer by at least one of heating, ultrasound, UV irradiation, and γ-irradiation.

13. The method of claim 8, further comprising:
adding fresh water to the hydrogel filter media sorbent after treatment with corrosive gases to regenerate the hydrogel filter media sorbent.

14. The method of claim 8, further comprising:
flowing corrosive gasses over the hydrogel filter media sorbent to selectively adsorb the corrosive gases from the flow using polymer networks of gel-based filters in the sorbent.
